(19) United States
(12) Patent Application Publication
(10) Pub. No.: US 2024/0388998 A1
(43) Pub. Date: Nov. 21, 2024

(54) METHOD AND APPARATUS FOR MANAGING CELL BARRING IN WIRELESS COMMUNICATION SYSTEM

(71) Applicant: Samsung Electronics Co., Ltd., Suwon-si, Gyeonggi-do (KR)

(72) Inventor: Anil AGIWAL, Suwon-si (KR)

(21) Appl. No.: 18/694,668

(22) PCT Filed: Sep. 27, 2022
(86) PCT No.: PCT/KR2022/014474

§ 371 Date: Mar. 22, 2024

(30) Foreign Application Priority Data
Sep. 27, 2021 (KR) 10-2021-0127548

(51) Int. Cl. H04W 48/02; H04W 48/12; H04W 48/20

(52) U.S. Cl. CPC H04W 48/02; H04W 48/12; H04W 48/20

(57) ABSTRACT

The disclosure relates to a 5G or 6G communication system for supporting a higher data transmission rate. According to embodiment, the method comprises receiving system information block 1 (SIB1) from a cell; and in case that the UE is a redcap UE and an intra frequency reselection field is not present in the SIB1, excluding the cell as a candidate for cell selection or reselection for predetermined duration and reselecting another cell on a same frequency as the cell.

### TECHNICAL FIELD

The disclosure relates to a method and an apparatus for managing cell barring in a wireless communication system. More particularly, the disclosure relates to cell barring of a redcap UE in the wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-operation random access for simplifying random access procedures (2-operation RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In one aspect, method of managing the cell baring for the redcap UE in the wireless communication system is required.

### Solution to Problem

According to an embodiment of the disclosure, the method of managing cell barring by the UE comprises receiving system information block 1 (SIB1) from a cell; and in case that the UE is a redcap UE and an intra frequency reselection field is not present in the SIB1, excluding the cell as a candidate for cell selection or reselection for predetermined duration and reselecting another cell on a same frequency as the cell.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates an example of UE operations for barring.

FIG. 2 illustrates an example of UE operations for the barring.

FIG. 3 illustrates an example of UE operations for the barring due to failure to acquire SIB 1.

FIG. 4 is a block diagram of a structure of the UE according to an embodiment of the disclosure.

FIG. 5 is a block diagram of a structure of the base station according to an embodiment of the disclosure.

### BEST MODE FOR CARRYING OUT THE INVENTION

In one embodiment of the disclosure, a method performed by a user equipment in a wireless communication system is provided. The method includes receiving system information block 1 (SIB1) from a cell; and in case that the UE is a redcap UE and an intra frequency reselection field is not present in the SIB1, excluding the cell as a candidate for cell selection or reselection for predetermined duration and reselecting another cell on a same frequency as the cell.

The method according to the embodiment of the disclosure, further includes in case that the UE is unable to acquire the SIB1 and the UE is the redcap UE, reselecting another cell on a same frequency as the cell.

The method according to the embodiment of the disclosure, further includes in case that the UE is unable to acquire the SIB1 and the UE is not the redcap UE, reselecting another cell on a same frequency as the cell.

The method according to the embodiment of the disclosure, further includes in case that the UE is a redcap UE with one RX chain and a bar_1Rx field in the SIB1 is set to barred or in case that the UE is a redcap UE with two RX chains and a bar_2Rx field in the SIB1 is set to barred, based on the intra frequency reselection field is present in the SIB1, excluding the cell as a candidate for cell selection or reselection for predetermined duration.

The method according to the embodiment of the disclosure, further includes in case that the UE is a redcap UE with one RX chain and a bar_1Rx field in the SIB1 is set to barred or in case that the UE is a redcap UE with two RX chains and a bar_2Rx field in the SIB1 is set to barred, identifying the intra frequency reselection field in the SIB1; and in case that the cell operates in a licensed spectrum, based on the intra frequency selection field set to not allowed, excluding the cell and another cell on the same frequency as a candidate for cell reselection for predetermined duration.

The method according to the embodiment of the disclosure, further includes in case that the UE is a redcap UE with one RX chain and a bar_1Rx field in the SIB1 is set to barred or in case that the UE is a redcap UE with two RX chains and a bar_2Rx field in the SIB1 is set to barred, identifying the intra frequency reselection field in the SIB1; and in case that the cell belongs to a public land mobile network (PLMN) indicated as being equivalent to a registered PLMN or selected PLMN of the UE or in case that the cell belongs to registered stand-alone non-public network (SNPN) or selected SNPN of the UE, based on the intra frequency selection field set to not allowed, excluding the cell and another cell on the same frequency as a candidate for cell reselection for predetermined duration.

The method according to the embodiment of the disclosure, further includes: in case that the UE is a redcap UE with one RX chain and a bar_1Rx field in the SIB1 is set to barred or in case that the UE is a redcap UE with two RX chains and a bar_2Rx field in the SIB1 is set to barred, identifying the intra frequency reselection field in the SIB1; and in case that the cell operates in unlicensed spectrum and does not belong to a public land mobile network (PLMN) indicated as being equivalent to a registered PLMN or selected PLMN of the UE or registered stand-alone non-public network (SNPN) or selected SNPN of the UE, based on the intra frequency selection field set to not allowed, reselecting another cell on a same frequency as the cell.

In another embodiment, a user equipment in a wireless communication system is provided. The user equipment includes a transceiver; and at least one processor coupled with the transceiver and configured to: receive system information block 1 (SIB1) from a cell, and in case that the UE is a redcap UE and an intra frequency reselection field is not present in the SIB1, exclude the cell as a candidate for cell selection or reselection for predetermined duration and reselect another cell on a same frequency as the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### MODE FOR THE INVENTION

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Hereinafter, for convenience of explanation, the disclosure uses terms and names defined in the 3rd generation partnership project long term evolution (3GPP LTE) standards. However, the disclosure is not limited to the terms and names, and may also be applied to systems following other standards.

In the disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a user equipment (UE), a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

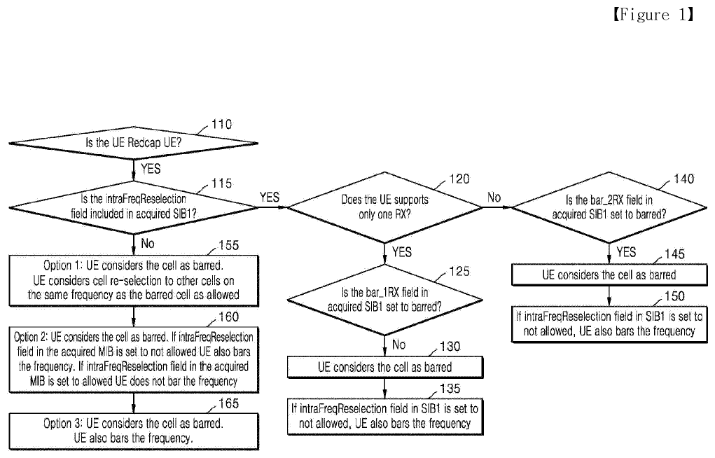

FIG. 1 through FIG. 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using beamforming. Beamforming techniques are used to mitigate the propagation path losses and to increase the propagation distance for communication at higher frequency band. The beamforming enhances the transmission and reception performance using a high-gain antenna. The beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using the beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

CA/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other acts as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

System information acquisition in fifth generation wireless communication system: In the fifth generation wireless communication system, node B (gNB) or base station in cell broadcast Synchronization Signal and PBCH block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the MIB and a number of SIBs where:
the MIB is always transmitted on the BCH with a periodicity of 80 ms and repetitions made within 80 ms and it includes parameters that are needed to acquire SIB1 from the cell.
the SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB1 includes mapping between SIBs and SI messages, periodicity of each SI message and SI window length. The scheduling information in SIB1 includes information regarding an indicator for each SI message, which indicates whether the concerned SI message is being broadcasted or not. If at least one SI message is not being broadcasted, SIB1 may include random access resources (PRACH preamble(s) and PRACH resource(s)) for requesting gNB to broadcast one or more SI message(s).
SIBs other than SIB1 are carried in SystemInformation (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.
UE acquires SIB1 from the camped or serving cell. UE check the BroadcastStatus bit in SIB1 for SI message which UE needs to acquire. SI request configuration for SUL is signaled by gNB using the IE si-RequestConfigSUL in SIB1. If the IE si-RequestConfigSUL is not present in SIB1, UE considers that SI request configuration for SUL is not signaled by gNB. SI request configuration for NUL is signaled by gNB using the IE si-RequestConfig in SIB1. If the IE si-RequestConfig is not present in SIB1, UE considers that SI request configuration for NUL is not signaled by gNB. If SI message which UE needs to acquire is not being broadcasted (i.e. BroadcastStatus bit is set to zero), UE initiates transmission of SI request. The procedure for SI request transmission is as follows:
If SI request configuration is signaled by gNB for SUL, and criteria to select SUL is met (i.e. RSRP derived from SSB measurements of camped or serving cell<rsrp-ThresholdSSB-SUL, where rsrp-ThresholdSSB-SUL is signaled by gNB (e.g. in broadcast signaling such as SIB1)): UE initiate transmission of SI request based on Msg1 based SI request on SUL. In other words, UE initiates Random Access procedure using the PRACH preamble(s) and PRACH resource(s) in SI request configuration of SUL. UE transmits Msg1 (i.e. Random access preamble) and waits for acknowledgement for SI request. Random access resources (PRACH preamble(s) and PRACH occasions(s)) indicated in SI request configuration of SUL is used for Msg1. Msg1 is transmitted on SUL. If acknowledgement for SI request is received, UE monitors the SI window of the requested SI message in one or more SI period(s) of that SI message.
Else if SI request configuration is signaled by gNB for NUL and criteria to select NUL is met (i.e. NUL is selected if SUL is supported in camped or serving cell and RSRP derived from SSB measurements of camped or serving cell>=rsrp-ThresholdSSB-SUL; OR NUL is selected if SUL is not supported in serving cell): UE initiate transmission of SI request based on Msg1 based SI request on NUL (350). In other words, UE initiates Random Access procedure using the PRACH preamble(s) and PRACH resource(s) in SI request configuration of NUL. UE transmits Msg1 (i.e. Random access preamble) and waits for acknowledgement for SI request. Random access resources (PRACH preamble(s) and PRACH occasions(s)) indicated in SI request configuration of NUL is used for Msg1. Msg1 is transmitted on NUL. If acknowledgement for SI request is received, UE monitors the SI window of the requested SI message in one or more SI period(s) of that SI message.
Else UE initiate transmission of SI request based on Msg3 based SI request. In other words, UE initiate transmission of RRCSystemInfoRequest message (345). UE transmits Msg1 (i.e. Random access preamble) and waits for random access response. Common random access resources (PRACH preamble(s) and PRACH occasions(s)) are used for Msg1. In the UL grant received in random access response, UE transmits RRCSystemInfoRequest message and waits for acknowledgement for SI request (i.e. RRCSystemInfoRequest message). If acknowledgement for SI request (i.e. RRCSystemInfoRequest message) is received, UE monitors the SI window of the requested SI message in one or more SI period(s) of that SI message. Note that if SUL is configured, UL carrier for Msg1 transmission will be selected by UE in similar manner as selected by UE for Msg1 based SI request. SUL is the selected UL carrier, if RSRP derived from SSB measurements of camped or serving cell<rsrp-ThresholdSSB-SUL where rsrp-ThresholdSSB-SUL is signaled by gNB (e.g. in broadcast signaling such as SIB1). NUL is the selected UL carrier, if RSRP derived from SSB measurements of camped or serving cell>=rsrp-ThresholdSSB-SUL where rsrp-ThresholdSSB-SUL is signaled by gNB (e.g. in broadcast signalling such as SIB1).

### Cell Barring in Fifth Generation Wireless Communication System:

Upon receiving the MIB the UE shall:
1> if the UE is in RRC_IDLE or in RRC_INACTIVE, or if the UE is in RRC_CONNECTED while T311 is running:
2> if the cellBarred in the acquired MIB is set to barred:
3> consider the cell as barred;
3> if intraFreqReselection field in the acquired MIB is set to notAllowed; and
3> if the cell operates in licensed spectrum, or the cell belongs to a PLMN which is indicated as being equivalent to the registered PLMN or the selected PLMN of the UE, or the cell belongs to the registered SNPN or the selected SNPN of the UE:
4> consider cell re-selection to other cells on the same frequency as the barred cell as not allowed.
3> else:
4> consider cell re-selection to other cells on the same frequency as the barred cell as allowed.
2> else:
3> apply the received systemFrameNumber, pdcch-ConfigSIB1, subCarrierSpacingCommon, ssb-SubcarrierOffset and dmrs-TypeA-Position.

The UE shall:
1> if in RRC_IDLE or in RRC_INACTIVE or in RRC_CONNECTED while T311 is running:
2> if the UE is unable to acquire the MIB:
3> consider the cell as barred and
3> perform barring as if intraFreqReselection is set to allowed;
2> else if the UE is unable to acquire the SIB1:
3> consider the cell as barred
3> if the cell operates in licensed spectrum and intraFreqReselection in MIB is set to notAllowed:
4> consider cell re-selection to other cells on the same frequency as the barred cell as not allowed
3> else:
4> consider cell re-selection to other cells on the same frequency as the barred cell as allowed

A RedCap specific IFRI (Intra frequency reselection indication) is specified in SIB1. IFRI for RedCap UEs in SIB1 is common for UEs with 1 Rx or 2 Rx branches. If RedCap-specific IFRI is absent from broadcast SI, the UE considers the cell does not support RedCap. RedCap UE applies the existing cellBarred field in MIB. Separate in-dications in SIB1 for barring RedCap UEs with 1 Rx chain and 2 Rx chains are specified.

A RedCap UE is the UE which supports Reduced number of UE RX/TX antennas, reduced bandwidth, relaxed UE processing time, relaxed UE processing capability, reduced Maximum number of DL MIMO layers, Relaxed maximum modulation order, Duplex operation.

It is required to define an operation of the UE, if UE is redcap UE and IFRI bit in SIB1 is not present.

It is required to define an operation of the UE, if UE fails to acquire SIB1.

### Embodiment 1

FIG. 1 illustrates an example of UE operations for barring.
The UE acquires/receives Master Information Block (MIB) from a cell (operation 105). The MIB is transmitted in a cell on Physical broadcast channel (PBCH).
The UE acquires SIB1
If the UE is a red cap UE (operation 110) and if intraFreqReselection field in acquired SIB1 is present/included (operation 115):
If the UE is 1 RX UE (i.e. the UE supports only one RX chain for receiving gNB transmissions) (operation 120) and bar_1RX field in acquired the SIB1 is set to barred (or bar_1RX field in acquired SIB1 is set to TRUE) (operation 125):
   The UE considers the cell as barred (i.e. does not consider this cell as candidate for cell selection/reselection) (operation 130). The UE bars the cell for a pre-defined duration (e.g. 300 s)
   If intraFreqReselection field in the SIB1 is set to not allowed, the UE also bars the frequency (i.e. the UE considers cell re-selection to other cells on the same frequency as the barred cell as not allowed). Barring is for a pre-defined duration e.g. 300 s. (operation 135)
If UE is 2 RX UE (i.e. UE supports two RX chains for receiving gNB transmissions) and bar_2RX field in acquired SIB1 is set to barred (or bar_2RX field in acquired SIB1 is set to TRUE) (operation 140):
   The UE considers the cell as barred (i.e. does not consider this cell as candidate for cell selection/reselection). UE bars the cell for a pre-defined duration (e.g. 300 s) (operation 145)
   If intraFreqReselection field in SIB1 is set to not allowed, UE also bars the frequency (i.e. UE considers cell re-selection to other cells on the same frequency as the barred cell as not allowed). Barring is for a pre-defined duration e.g. 300 s. (operation 150)
If UE is a red cap UE and if intraFreqReselection field in acquired SIB1 is not present/included: (operation 115)
In one embodiment, UE considers the cell as barred (i.e. does not consider this cell as candidate for cell selection/reselection) for a pre-defined duration e.g. 300 s. UE considers cell re-selection to other cells on the same frequency as the barred cell as allowed (i.e. UE does not bar the frequency). (operation 155)
In another embodiment, the UE considers the cell as barred (i.e. does not consider this cell as candidate for cell selection/reselection) for a pre-defined duration e.g. 300 s. If intraFreqReselection field in the acquired MIB is set to not allowed UE also bars the frequency (i.e. the UE considers cell re-selection to other cells on the same frequency as the barred cell as not allowed). Barring is for a pre-defined duration e.g. 300 s. If intraFreqReselection field in the acquired MIB is set to allowed UE does not bar the frequency (i.e. the UE considers cell re-selection to other cells on the same frequency as the barred cell as allowed). (operation 160)
In another embodiment, the UE considers the cell as barred (i.e. does not consider this cell as candidate for cell selection/reselection) for a pre-defined duration e.g. 300 s. the UE also bars the frequency (i.e. the UE considers cell re-selection to other cells on the same frequency as the barred cell as not allowed). Barring is for a pre-defined duration e.g. 300 s. (operation 165)

### Embodiment 2

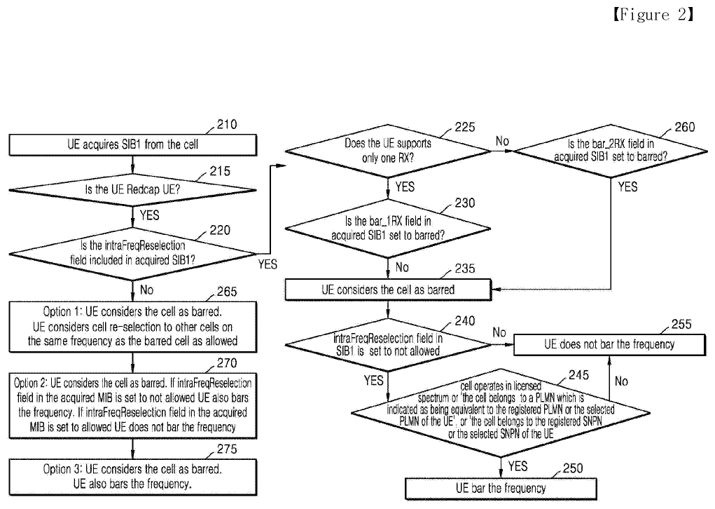

FIG. 2 illustrates an example of UE operations for the barring.
The UE acquires/receives Master Information Block (MIB) from a cell (operation 205). The MIB is transmitted in a cell on Physical broadcast channel (PBCH).
The UE acquires SIB1 (operation 210)
If the UE is a red cap UE (operation 215) and if intraFreqReselection field in acquired SIB1 is present/included (operation 220):
If UE is 1 RX UE (i.e. UE supports only one RX chain for receiving gNB transmissions) (operation 225) and bar_1RX field in acquired SIB1 is set to barred (operation 230):
   The UE considers the cell as barred (i.e. does not consider this cell as candidate for cell selection/reselection) for a pre-defined duration e.g. 300 s (operation 235).
   If the cell operates in licensed spectrum or the cell belongs to a PLMN which is indicated as being equivalent to the registered PLMN or the selected PLMN of the UE, or the cell belongs to the registered SNPN or the selected SNPN of the UE; and
   If intraFreqReselection field in SIB1 is set to not allowed (operation 240):
The UE also bars the frequency (i.e. UE considers cell re-selection to other cells on the same frequency as the barred cell as not allowed). Barring is for a pre-defined duration e.g. 300 s (operation 250).
   Else (e.g. a) If intraFreqReselection field in SIB1 is set to allowed′ b) If intraFreqReselection field in SIB1 is set to not allowed and If the cell operates in unlicensed spectrum and the cell belongs to a PLMN which is not indicated as being equivalent to the registered PLMN or the selected PLMN of the UE; c) If intraFreqReselection field in SIB1 is set to not allowed and If the cell operates in unlicensed spectrum and the cell does not belongs to the registered SNPN or the selected SNPN of the UE) (operation 245)
The UE does not bar the frequency i.e. consider cell re-selection to other cells on the same frequency as the barred cell as allowed (operation 255)
   Else
If the UE is 2 RX UE (i.e. UE supports two RX chains for receiving gNB transmissions) and bar_2RX field in acquired SIB1 is set to barred (operation 260)
   The UE considers the cell as barred (i.e. does not consider this cell as candidate for cell selection/reselection) for a pre-defined duration e.g. 300 s (operation 235)
   If the cell operates in licensed spectrum or ‘the cell belongs to a PLMN which is indicated as being equivalent to the registered PLMN or the selected PLMN of the UE’, or ‘the cell belongs to the registered SNPN or the selected SNPN of the UE’ (operation 245) and
   If intraFreqReselection field in SIB1 is set to not allowed: (operation 240)
UE also bars the frequency (i.e. UE considers cell re-selection to other cells on the same frequency as the barred cell as not allowed). Barring is for a pre-defined duration e.g. 300 s. (operation 250)
   Else (e.g. a) If intraFreqReselection field in SIB1 is set to allowed′ b) If intraFreqReselection field in SIB1 is set to not allowed and If the cell operates in unlicensed spectrum and the cell belongs to a PLMN which is not indicated as being equivalent to the registered PLMN or the selected PLMN of the UE; c) If intraFreqReselection field in SIB1 is set to not allowed and If the cell operates in unlicensed spectrum and the cell does not belongs to the registered SNPN or the selected SNPN of the UE) (operation 245)
UE does not bar the frequency i.e. consider cell re-selection to other cells on the same frequency as the barred cell as allowed (operation 255)
If UE is a red cap UE and if intraFreqReselection field in acquired SIB1 is not present/included:
In one embodiment, UE considers the cell as barred i.e. does not consider this cell as candidate for cell selection/reselection) for a pre-defined duration e.g. 300 s. UE considers cell re-selection to other cells on the same frequency as the barred cell as allowed. Barring is for a pre-defined duration e.g. 300 s. (operation 265)
In another embodiment, UE considers the cell as barred i.e. does not consider this cell as candidate for cell selection/reselection) for a pre-defined duration e.g. 300 s. If intraFreqReselection field in the acquired MIB is set to not allowed UE also bars the frequency (i.e. UE considers cell re-selection to other cells on the same frequency as the barred cell as not allowed). Barring is for a pre-defined duration e.g. 300 s. If intraFreqReselection field in the acquired MIB is set to allowed UE does not bar the frequency (i.e. UE considers cell re-selection to other cells on the same frequency as the barred cell as allowed) (operation 270)
In another embodiment, UE considers the cell as barred i.e. does not consider this cell as candidate for cell selection/reselection) for a pre-defined duration e.g. 300 s. UE also bars the frequency (i.e. considers cell re-selection to other cells on the same frequency as the barred cell as not allowed). Barring is for a pre-defined duration e.g. 300 s. (operation 275)

### Embodiment 3

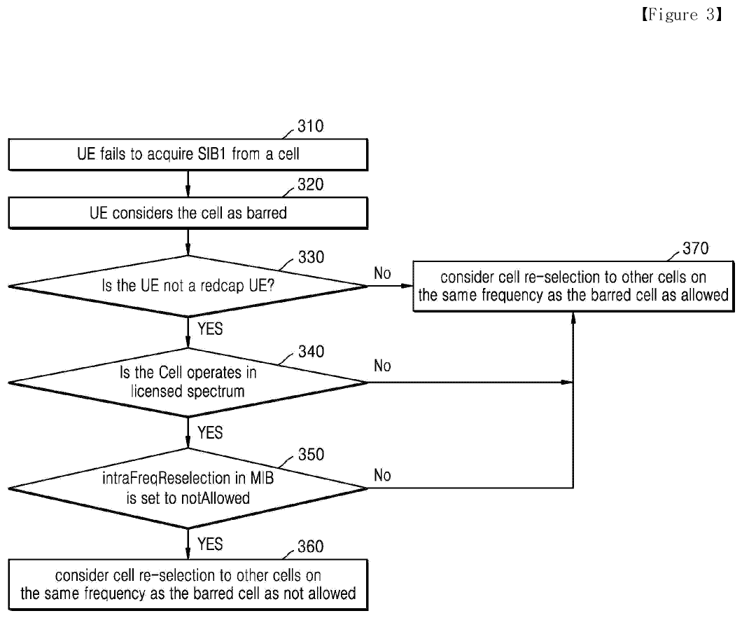

FIG. 3 illustrates an example of UE operations for the barring due to failure to acquire SIB 1.
if the UE is unable to acquire the SIB1 (operation 310):
   UE considers the cell as barred (operation 320)
   If the UE is not a redcap UE (operation 330) and if the cell operates in licensed spectrum (operation 340) and intraFreqReselection in MIB is set to notAllowed (operation 350):
   consider cell re-selection to other cells on the same frequency as the barred cell as not allowed (operation 360)
   else:
   consider cell re-selection to other cells on the same frequency as the barred cell as allowed (operation 370)

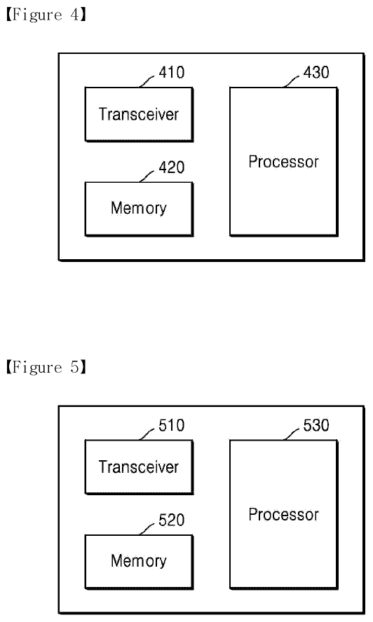

FIG. 4 is a block diagram of a structure of the UE according to an embodiment of the disclosure.

Referring to FIG. 4, the UE according to the disclosure may include a transceiver 410, a memory 420, and a processor 430. According to the above-described communication method of the UE, the processor 430, the transceiver 410, and the memory 420 of the UE may operate. However, components of the UE are not limited to the above-described example. For example, the UE may include components that are more than or fewer than the above-described components. Moreover, the processor 430, the transceiver 410, and the memory 420 may be implemented in the form of a single chip. The processor 430 may refer to one or more processors.

The transceiver 410 may collectively refer to a receiver and a transmitter of the UE, and transmit and receive a signal to and from the base station. The signal transmitted and received to and from the base station may include control information and data. To this end, the transceiver 410 may include an RF transmitter that up-converts and amplifies a frequency of a transmission signal and an RF receiver that low-noise-amplifies a received signal and down-converts a frequency. However, this is merely an example of the transceiver 410, components of which are not limited to the RF transmitter and the RF receiver.

The transceiver 410 may receive a signal through a radio channel and output the received signal to the processor 430, and transmit a signal output from the processor 430 through the radio channel.

The memory 420 may store programs and data required for an operation of the UE. The memory 420 may also store control information or data included in a signal obtained by the UE. The memory 420 may include a storage medium, such as ROM, RAM, hard-disk, CD-ROM, DVD, and the like, or a combination thereof.

The processor 430 may control a series of processes such that the UE operates according to the above-described embodiment of the disclosure. For example, the processor 430 may control components of the UE to perform the method of managing barring according to an embodiment of the disclosure. For example, the transceiver 410 may receive a data signal including a control signal, and the processor 430 may determine a reception result for the data signal.

FIG. 5 is a block diagram of a structure of the base station according to an embodiment of the disclosure.

Referring to FIG. 5, the base station according to the disclosure may include a transceiver 510, a memory 520, and a processor 530. According to the above-described communication method of the base station, the processor 530, the transceiver 510, and the memory 520 of the base station may operate. However, components of the base station are not limited to the above-described example. For example, the base station may include components that are more than or fewer than the above-described components. Moreover, the processor 530, the transceiver 510, and the memory 520 may be implemented in the form of a single chip. The processor 530 may refer to one or more processors.

The transceiver 510 may collectively refer to a receiver and a transmitter of the base station, and transmit and receive a signal to and from the UE. The signal transmitted and received to and from the base station may include control information and data. To this end, the transceiver 510 may include an RF transmitter that up-converts and amplifies a frequency of a transmission signal and an RF receiver that low-noise-amplifies a received signal and down-converts a frequency. However, this is merely an example of the transceiver 510, components of which are not limited to the RF transmitter and the RF receiver.

The transceiver 510 may receive a signal through a radio channel and output the received signal to the processor 530, and transmit a signal output from the processor 530 through the radio channel.

The memory 520 may store programs and data required for an operation of the base station. The memory 520 may also store control information or data included in a signal obtained by the base station. The memory 520 may include a storage medium, such as ROM, RAM, hard-disk, CD-ROM, DVD, and the like, or a combination thereof.

The processor 530 may control a series of processes such that the base station operates according to the above-described embodiment of the disclosure. For example, the processor 530 may control components of the base station to perform the method of managing barring according to an embodiment of the disclosure. For example, the transceiver 510 may receive a data signal including a control signal, and the processor 530 may determine a reception result for the data signal.

The methods according to the embodiments of the disclosure described in the claims or specification of the disclosure may be implemented by hardware, software, or a combination thereof.

When the methods are implemented as software, a computer-readable storage medium or a computer program product having stored therein one or more programs (software modules) may be provided. The one or more programs stored in the computer-readable storage medium or computer program product may be configured for execution by one or more processors in an electronic device. The one or more programs may include instructions that cause the electronic device to perform the methods according to the embodiments of the disclosure described in the claims or the specification of the disclosure.

These programs (software modules and software) may be stored in RAMs, non-volatile memories including flash memories, ROMs, electrically erasable programmable ROMs (EEPROMs), magnetic disc storage devices, CD-ROMs, DVDs, other types of optical storage devices, or magnetic cassettes. The programs may be stored in a memory configured by a combination of some or all of such storage devices. In addition, each of the memories may be provided in plurality.

The programs may be stored in an attachable storage device of the electronic device accessible via the communication network, such as Internet, Intranet, a local area network (LAN), a wireless LAN (WLAN), or storage area network (SAN), or a communication network by combining the networks. The storage device may access a device performing the embodiment of the disclosure through an external port. Furthermore, a separate storage device in a communication network may access a device performing the embodiment of the disclosure.

In the disclosure, the term “computer program product” or “computer-readable medium” may be used to overall indicate a memory, a hard disk installed in a hard disk drive, a signal, and the like. The term “computer program product” or “computer-readable medium” may be a means for providing a method of configuring a transmission power of an SL synchronization channel and an SL feedback channel according to the disclosure.

Disclosed embodiments of the disclosure may provide an apparatus and method for effectively providing a service in a wireless communication system.

In the embodiments of the disclosure, components included in the disclosure have been expressed as singular or plural according to the provided embodiment of the disclosure. However, singular or plural expressions have been selected properly for a condition provided for convenience of a description, and the disclosure is not limited to singular or plural components, and components expressed as plural may be configured as a single component or a component expressed as singular may also be configured as plural components.

Meanwhile, the embodiments of the disclosure disclosed in the specification and drawings have been provided to easily describe the disclosure and to help with the understanding of the disclosure, and are not intended to limit the scope of the disclosure. In other words, it is apparent to one of ordinary skill in the art that other modifications based on the technical spirit of the disclosure may be carried out. In addition, the embodiments of the disclosure may be used in combination when necessary. For example, an embodiment of the disclosure may be combined with some parts of another embodiment of the disclosure. In addition, other modifications based on the technical spirit of the above-described embodiment of the disclosure may also be carried out in other systems, e.g., an LTE system, a 5G system, an NR system, and the like.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method of managing cell barring by a user equipment (UE), the method comprising:
receiving system information block 1 (SIB1) from a cell; and
in case that the UE is a redcap UE and an intra frequency reselection field is not present in the SIB1, excluding the cell as a candidate for cell selection or cell reselection for predetermined duration and reselecting another cell on a same frequency as the cell.

2. The method of claim 1, further comprising:
in case that the UE is unable to acquire the SIB1 and the UE is the redcap UE, reselecting another cell on the same frequency as the cell.

3. The method of claim 1, further comprising:
in case that the UE is unable to acquire the SIB1 and the UE is not the redcap UE, reselecting another cell on a same frequency as the cell.

4. The method of claim 1, further comprising:
in case that the UE is the redcap UE with one RX chain and a bar_1Rx field in the SIB1 is set to barred or in case that the UE is the redcap UE with two RX chains and a bar_2Rx field in the SIB1 is set to barred, based on the intra frequency reselection field in the SIB1, excluding the cell as the candidate for the cell selection or the cell reselection for the predetermined duration.

5. The method of claim 1, further comprising:
in case that the UE is the redcap UE with one RX chain and a bar_1Rx field in the SIB1 is set to barred or in case that the UE is the redcap UE with two RX chains and a bar_2Rx field in the SIB1 is set to barred, identifying the intra frequency reselection field in the SIB1; and
in case that the cell operates in a licensed spectrum, based on the intra frequency reselection field set to not allowed, excluding the cell and another cell on the same frequency as the candidate for the cell reselection for the predetermined duration.

6. The method of claim 1, further comprising:
in case that the UE is the redcap UE with one RX chain and a bar_1Rx field in the SIB1 is set to barred or in case that the UE is the redcap UE with two RX chains and a bar_2Rx field in the SIB1 is set to barred, identifying the intra frequency reselection field in the SIB1; and
in case that the cell belongs to a public land mobile network (PLMN) indicated as being equivalent to a registered PLMN or selected PLMN of the UE or in case that the cell belongs to registered stand-alone non-public network (SNPN) or selected SNPN of the UE, based on the intra frequency reselection field set to not allowed, excluding the cell and another cell on the same frequency as the candidate for the cell reselection for the predetermined duration.

7. The method of claim 1, further comprising:
in case that the UE is the redcap UE with one RX chain and a bar_1Rx field in the SIB1 is set to barred or in case that the UE is the redcap UE with two RX chains and a bar_2Rx field in the SIB1 is set to barred, identifying the intra frequency reselection field in the SIB1; and
in case that the cell operates in unlicensed spectrum and does not belong to a public land mobile network (PLMN) indicated as being equivalent to a registered PLMN or selected PLMN of the UE or registered stand-alone non-public network (SNPN) or selected SNPN of the UE, based on the intra frequency reselection field set to not allowed, reselecting another cell on the same frequency as the cell.

8. A user equipment (UE) comprising:
a transceiver; and
at least one processor coupled with the transceiver and configured to:
receive system information block 1 (SIB1) from a cell, and
in case that the UE is a redcap UE and an intra frequency reselection field is not present in the SIB1, exclude the cell as a candidate for cell selection or cell reselection for predetermined duration and reselect another cell on a same frequency as the cell.

9. The UE of claim 8, wherein the processor is further configured to:
in case that the UE is unable to acquire the SIB1 and the UE is the redcap UE, reselect another cell on the same frequency as the cell.

10. The UE of claim 8, wherein the processor is further configured to:
in case that the UE is unable to acquire the SIB1 and the UE is not the redcap UE, reselect another cell on the same frequency as the cell.

11. The UE of claim 8, wherein the processor is further configured to:
in case that the UE is the redcap UE with one RX chain and a bar_1Rx field in the SIB1 is set to barred or in case that the UE is the redcap UE with two RX chains and a bar_2Rx field in the SIB1 is set to barred, based on the intra frequency reselection field in the SIB1, exclude the cell as the candidate for the cell selection or the cell reselection for the predetermined duration.

12. The UE of claim 8, wherein the processor is further configured to:
in case that the UE is the redcap UE with one RX chain and a bar_1Rx field in the SIB1 is set to barred or in case that the UE is the redcap UE with two RX chains and a bar_2Rx field in the SIB1 is set to barred, identify the intra frequency reselection field in the SIB1, and
in case that the cell operates in a licensed spectrum, based on the intra frequency reselection field set to not allowed, exclude the cell and another cell on the same frequency as the candidate for the cell reselection for the predetermined duration.

13. The UE of claim 8, wherein the processor is further configured to:
in case that the UE is the redcap UE with one RX chain and a bar_1Rx field in the SIB1 is set to barred or in case that the UE is the redcap UE with two RX chains and a bar_2Rx field in the SIB1 is set to barred, identify the intra frequency reselection field in the SIB1, and
in case that the cell belongs to a public land mobile network (PLMN) indicated as being equivalent to a registered PLMN or selected PLMN of the UE or in case that the cell belongs to registered stand-alone non-public network (SNPN) or selected SNPN of the UE, based on the intra frequency reselection field set to not allowed, exclude the cell and another cell on the same frequency as the candidate for the cell reselection for the predetermined duration.

14. The UE of claim 8, wherein the processor is further configured to:
in case that the UE is the redcap UE with one RX chain and a bar_1Rx field in the SIB1 is set to barred or in case that the UE is the redcap UE with two RX chains and a bar_2Rx field in the SIB1 is set to barred, identify the intra frequency reselection field in the SIB1, and
in case that the cell operates in unlicensed spectrum and does not belong to a public land mobile network (PLMN) indicated as being equivalent to a registered PLMN or selected PLMN of the UE or registered stand-alone non-public network (SNPN) or selected SNPN of the UE, based on the intra frequency reselection field set to not allowed, reselect another cell on the same frequency as the cell.
